(19) United States
(12) Patent Application Publication
(10) Pub. No.: US 2019/0137047 A1
(43) Pub. Date: May 9, 2019

(54) LED LAMP WITH WINDABLE FILAMENT AND PROCESS FOR MAKING SAME

(71) Applicant: Suzhou Industrial Park Hexin Clean Electric Appliance Co., Ltd., Suzhou (CN)

(72) Inventor: Yiwen Hu, Suzhou (CN)

(21) Appl. No.: 16/240,790

(22) Filed: Jan. 6, 2019

Related U.S. Application Data
(63) Continuation-in-part of application No. PCT/CN2016/100284, filed on Sep. 27, 2016.

(30) Foreign Application Priority Data
Aug. 24, 2016 (CN) 201610711495.8

(51) Int. Cl. F21K 9/232; F21V 19/00; F21K 9/238; F21K 9/90; F21S 4/22

(52) U.S. Cl. CPC F21K 9/232; F21V 19/003; F21Y 2115/10; F21K 9/90; F21S 4/22; F21K 9/238

(57) ABSTRACT

An LED lamp with a windable filament and a process for making the same. The LED lamp includes a bulb shell, a support, an electrical connector and a driver. The support is externally connected to the bulb shell, and forms a vacuum sealed cavity with the bulb shell. The support is connected to a light bar through an electrical lead wire. The light bar placed in the vacuum sealed cavity is of a strip-shaped structure, and is provided with a substrate. A plurality of electrical connection circuits are uniformly arranged on the substrate. An LED chip is connected to the plurality of electrical connection circuits. A fluorescent colloid is provided on the substrate.

### CROSS-REFERENCE TO RELATED APPLICATIONS

This application is a continuation-in-part of International Patent Application No. PCT/CN2016/100284, filed on Sep. 27, 2016, which claims the benefit of priority from Chinese Application No. 201610711495.8, filed on Aug. 24, 2016. The contents of the aforementioned applications, including any intervening amendments thereto, are incorporated herein by reference in its entirety.

### TECHNICAL FIELD

The present disclosure relates to LED lamps, and more specifically to an LED lamp with a windable filament and a process for making the same.

### BACKGROUND

In the existing technologies of filament lamps and light bars, although a single filament enables global (360°) illumination, many shades (commonly known as ghosts) appear after the lamp is assembled due to the interference of multiple filaments and supports. In the 4π filament technology, the use of a transparent substrate may lead to the leakage of blue light. In addition, the 4π filament process and the substrate processing are complicated with high cost (the chip uses reduced power to improve the luminous efficiency and reduce the temperature).

Chinese Patent Application No. 201510712329.5 discloses a bent filament, where the substrate is produced according to the required pattern; double-sided die bonding is required to ensure that light on both sides of the substrate may emit; and the direction of the substrate is required to be adjusted during die bonding of the arc and reverse chip. This process is complicated with low yield rate and low efficiency, and one substrate can be only made into one pattern product.

The existing products have poor waterproof and dustproof performances due to the external power supply. The object of the present disclosure is to solve at least one of the above problems in the prior art.

On the other hand, flexible printed circuits (FPC) used as substrates are greatly deformed in the processing due to theirs flexibilities, so that the flexible printed circuits are difficult to process. Thus, a lot of processing fixtures and processes are required in the post-processing.

### SUMMARY

To overcome the shortcomings of the prior art, the present disclosure provides an LED lamp with a windable filament and a process for making the same. The special structure of the light bar and the process improve the efficiency and the sensory comfort of the LED lamp.

The LED lamp with a windable filament includes a bulb shell, a support, an electrical connector and a driver. The support is externally connected to the bulb shell, and forms a vacuum sealed cavity with the bulb shell. The support is connected to a light bar through an electrical lead wire. The light bar placed in the vacuum sealed cavity is of a strip-shaped structure, and is provided with a substrate. A plurality of electrical connection circuits are uniformly arranged on the substrate. An LED chip is provided on the plurality of electrical connection circuits, and a fluorescent colloid is provided on the substrate.

One end of the electrical lead wire is connected to the light bar through an electrode, and the other end of the electrical lead wire is connected to the voltage output end of the driver through a wire. The voltage input end of the driver is connected to the electrical connector, and the electrical connector is provided at the lower end of the support.

The light bar is of a strip-shaped structure formed by a flat plate through die bonding, welding, dispensing and baking. The light bar winds around its axis to 360° or more to form a winding structure, and the winding structure of the light bar may be one of a transverse winding structure, a vertical winding structure, a linear structure, an arc structure, a triangular structure, an elliptical structure, a trapezoidal structure, a square structure, a heart-shaped structure and a diamond-shaped structure.

The vacuum sealed cavity is filled with convective heat-dissipation gas with the thermal expansion coefficient different from the thermal expansion coefficient of air, and the convective heat-dissipation gas is at least one of helium, argon, hydrogen and neon.

Alternatively, the vacuum sealed cavity is filled with dry air.

The substrate is connected to the LED chip using a flip-chip process or a wire bonding process in an inverted arrangement, and the LED chip is connected to the plurality of electrical connection circuits through solders.

The substrate of an elongated sheet structure is made from a metal or a flexible circuit board. The thickness of the substrate is less than 0.6 mm, and the width of the substrate is less than 10 mm.

The cross section of the bulb shell has one of a circular shape, a fan shape, an elliptical shape, a triangular shape and a trapezoidal shape.

The LED chip is selected from one of a blue LED chip, a red LED chip, a yellow LED chip, a green LED chip, an ultraviolet LED chip and an infrared LED chip, and is excited by phosphor.

A process for making the LED lamp with a windable filament includes:

(1) fixing the substrate to the light bar;

(2) connecting the LED chip to the substrate using a flip-chip process or a wire bonding process in an inverted arrangement, wherein eutectic soldering, reflow soldering or conductive silver-filled epoxy adhesive is used in the process;

(3) coating the fluorescent colloid on the top of the substrate and the LED chip;

(4) winding the light bar;

(5) assembling the light bar, the bulb shell and the support into the lamp; and filling the vacuum sealed cavity of the lamp with the convective heat-dissipation gas or the dry air; and

(6) assembling the driver and the electrical connector to manufacture an LED lamp product.

Alternatively, in the step (2), both ends of the substrate are provided with a process cavity respectively, and the process cavity is clamped by an elastic fixture so that the substrate can be straightened to process.

The present disclosure over the prior art provides the LED lamp with a windable filament and the process for making the same. The special structure of the light bar and the process improve the efficiency and the sensory comfort of the LED lamp. The light bar winds around its axis to 360° or more to form a winding structure, and the winding structure of the light bar may be one of a transverse winding structure, a vertical winding structure, a linear structure, an arc structure, a triangular structure, an elliptical structure, a trapezoidal structure, a square structure, a heart-shaped structure and a diamond-shaped structure. The cross section of the bulb shell has one of a circular shape, a fan shape, an elliptical shape, a triangular shape and a trapezoidal shape, enabling a global (360°) illumination. The length of the filament may be increased by winding even a single filament to meet the power demand of light source.

The components can be connected in series or in parallel using the flip-chip process.

The vacuum sealed cavity can be filled with the dry air which has the same illumination effect as the convective heat-dissipation gas including helium, argon, hydrogen and neon. The process is simpler, and the cost is lower.

Both ends of the substrate are provided with a process cavity, respectively. The process cavity is clamped by an elastic fixture so that the substrate can be straightened to process, achieving planar processing and bending to use.

### BRIEF DESCRIPTION OF THE DRAWINGS

FIG. 1 is a schematic diagram of an LED lamp with a windable filament of the present disclosure;

FIG. 2 is a schematic diagram of a light bar;

FIG. 3 is a side view of the light bar; and

FIGS. 4-8 are schematic diagrams of the LED lamp with a windable filament in other embodiments.

### REFERENCE NUMERALS

1, substrate; 101, process cavity; 2, bulb shell; 3, vacuum sealed cavity; 31, convective heat-dissipation gas; 4, electrical lead wire; 5, support; 6, electrical connector; 7, electrode; 8, electrical connection circuit; 9, LED chip; and 10, fluorescent colloid; 11, light bar; 12, driver; 13, elastic fixture.

### DETAILED DESCRIPTION OF EMBODIMENTS

The present disclosure will be further described with reference to the accompanying drawings.

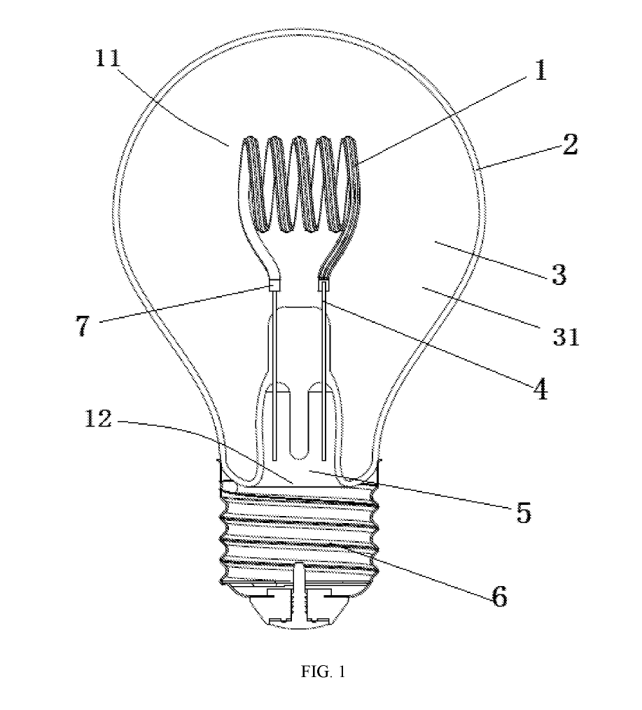

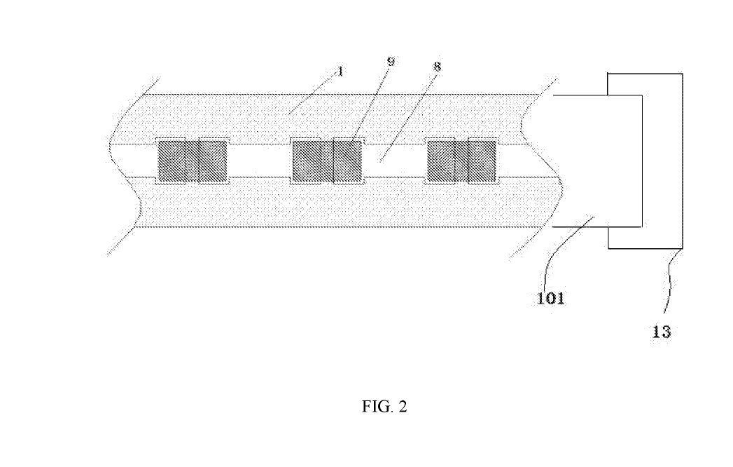

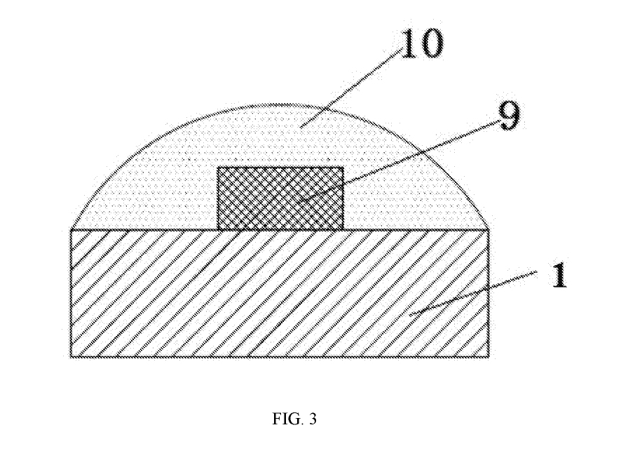

As shown in FIGS. 1-3, a support 5 is externally connected to a bulb shell 2, and forms a vacuum sealed cavity with the bulb shell 2. The support 5 is connected to a light bar 11 through an electrical lead wire 4. The light bar 11 of a strip-shaped structure is provided with a substrate 1. A plurality of electrical connection circuits 8 are uniformly arranged on the substrate 1. An LED chip 9 is provided on the plurality of electrical connection circuits 8, and a fluorescent colloid 10 is provided on the substrate 1.

One end of the electrical lead wire 4 is connected to the light bar 11 through an electrode 7, and the other end of the electrical lead wire 4 is connected to the voltage output end of the driver 12 through a wire. The voltage input end of the driver 12 is connected to an electrical connector 6, and the electrical connector 6 is provided at the lower end of the support 5.

The vacuum sealed cavity is filled with convective heat-dissipation gas 31 with the thermal expansion coefficient different from the thermal expansion coefficient of air, and the convective heat-dissipation gas 31 is at least one of helium, argon, hydrogen and neon.

Alternatively, the vacuum sealed cavity 3 can be filled with dry air which has the same illumination effect as the convective heat-dissipation gas including helium, argon, hydrogen and neon. The process is simpler, and the cost is lower.

The substrate 1 is connected to the LED chip 9 using a flip-chip process or a wire bonding process in an inverted arrangement, and the LED chip 9 is connected to the plurality of electrical connection circuits 8 through solders.

The substrate 1 of an elongated sheet structure is made from a metal or a flexible circuit board. The thickness of the substrate 1 is less than 0.6 mm, and the width of the substrate 1 is less than 10 mm.

The LED chip 9 is selected from one of a blue LED chip, a red LED chip, a yellow LED chip, a green LED chip, an ultraviolet LED chip and an infrared LED chip, and is excited by phosphor.

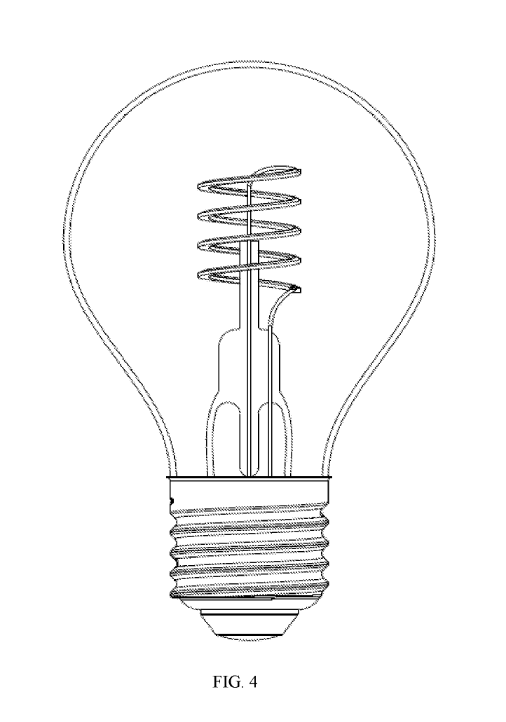

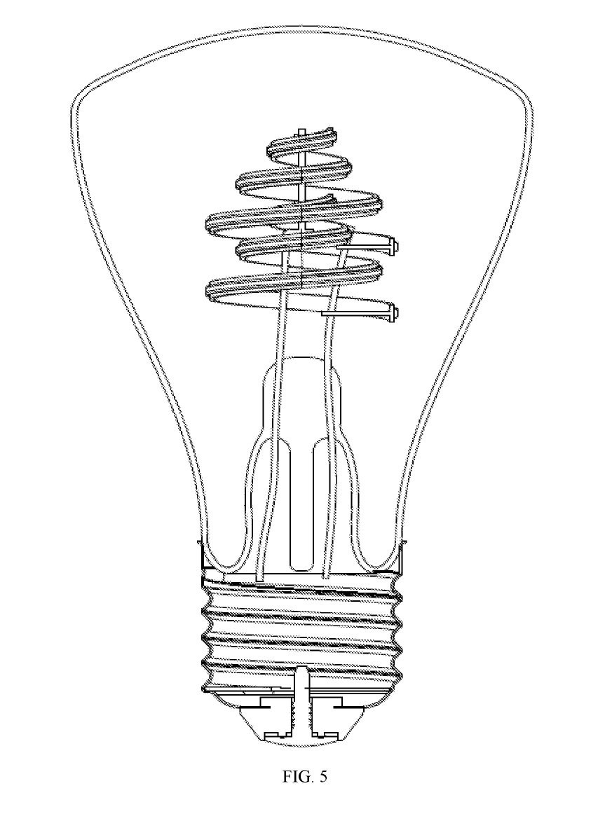

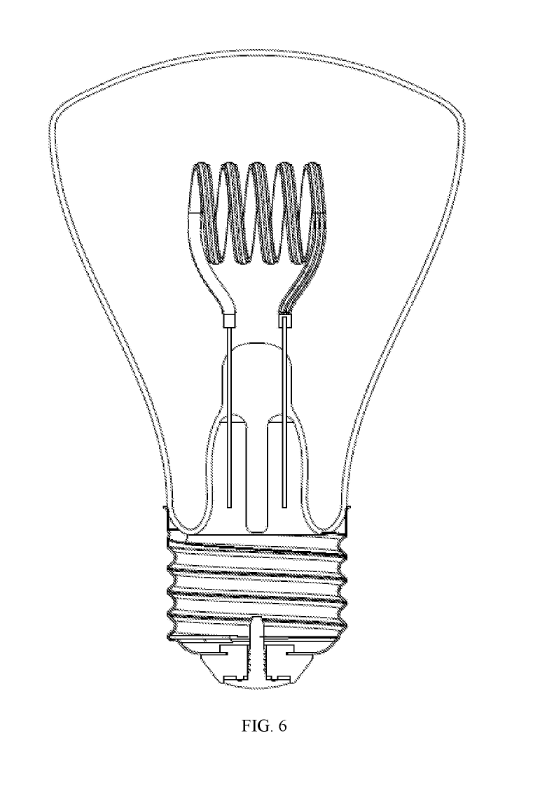

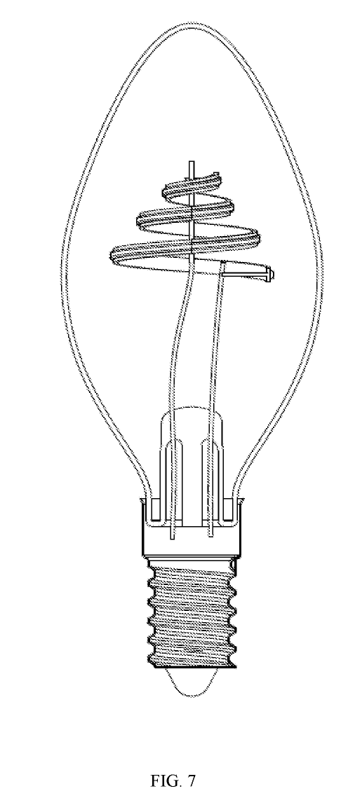

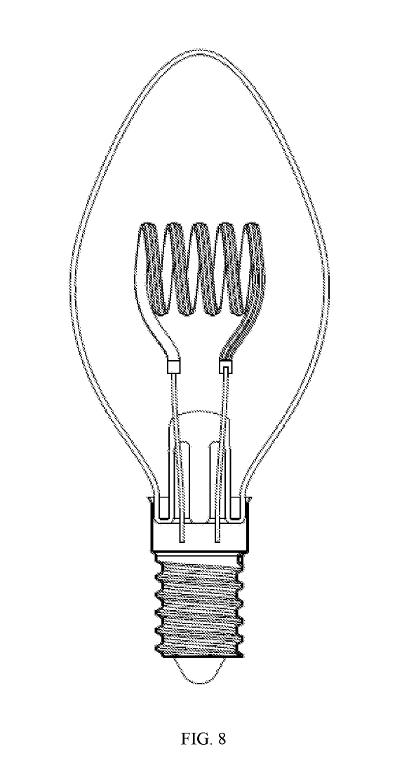

As shown in FIGS. 4-8, the light bar 11 is of a strip-shaped structure formed by a flat plate through die bonding, welding, dispensing and baking. Winding around the axis of the light bar 11, the winding structure of the light bar 11 may be one of a transverse winding structure, a vertical winding structure, a linear structure, an arc structure, a triangular structure, an elliptical structure, a trapezoidal structure, a square structure, a heart-shaped structure and a diamond-shaped structure. The cross section of the bulb shell 2 has one of a circular shape, a fan shape, an elliptical shape, a triangular shape and a trapezoidal shape, enabling a global (360°) illumination.

A process for making the LED lamp with a windable filament includes:

(1) fixing the substrate 1 to the light bar 11;

(2) connecting the LED chip 9 to the substrate 1 using a flip-chip process or a wire bonding process in an inverted arrangement, wherein eutectic soldering, reflow soldering or conductive silver-filled epoxy adhesive is used in the process;

(3) coating the fluorescent colloid 10 on the top of the substrate 1 and the LED chip 9;

(4) winding and shaping the light bar 11;

(5) assembling the light bar 11, the bulb shell 2 and the support 5 into a lamp; and filling the vacuum sealed cavity of the lamp with the convective heat-dissipation gas 31 or the dry air; and

(6) assembling the driver 12 and the electrical connector 6 to manufacture an LED lamp product.

Alternatively, in the step (2), a process cavity 101 is provided at both ends of the substrate 1 respectively. The process cavity 101 is clamped by an elastic fixture 13 so that the substrate 1 can be straightened to process, achieving planar processing and bending to use.

Because the substrate 1 is in a slit connection, the light bar 11 can be wound into various illuminants with different diameters, lengths and heights, enabling a global (360°) illumination. The support 5 and the bulb shell 2 form a sealed cavity without using the lamp wick, so the cost is reduced. The sealed cavity is filled with the convective heat-dissipation gas 31 with the thermal expansion coefficient different from the thermal expansion coefficient of air. Thus, with the temperature changing in the lamp, the convection is formed in the bulb shell to dissipate heat. The gas flows and circulates in the sealed cavity using the heat generated by the light source and the power supply, thereby taking the heat away. The making process is simple, and the shape, weight and sensitivity of the LED lamp are closest to those of the existing incandescent lamps, improving the efficiency and the sensory comfort of the LED lamp.

What is claimed is:

1. An LED lamp with a windable filament, comprising:
a bulb shell,
a support,
an electrical connector, and
a driver,
wherein the support is externally connected to the bulb shell; the support and the bulb shell form a vacuum sealed cavity; the support is connected to a light bar through an electrical lead wire; the light bar placed in the vacuum sealed cavity is of a strip-shaped structure, and is provided with a substrate; a plurality of electrical connection circuits are uniformly arranged on the substrate; an LED chip is connected to the plurality of electrical connection circuits; and a fluorescent colloid is provided on the substrate;
wherein the light bar is of a strip-shaped structure formed by a flat plate through die bonding, welding, dispensing and baking; and a winding structure of the light bar is formed by winding around an axis of the light bar for more than 360°.

2. The LED lamp of claim 1, wherein an end of the electrical lead wire is connected to the light bar through an electrode; the other end of the electrical lead wire is connected to a voltage output end of the driver through a wire; a voltage input end of the driver is connected to the electrical connector; and the electrical connector is provided at a lower end of the support.

3. The LED lamp of claim 1, wherein the winding structure of the light bar is one of a transverse winding structure, a vertical winding structure, a linear structure, an arc structure, a triangular structure, an elliptical structure, a trapezoidal structure, a square structure, a heart-shaped structure and a diamond-shaped structure.

4. The LED lamp of claim 1, wherein the vacuum sealed cavity is filled with convective heat-dissipation gas with a thermal expansion coefficient different from a thermal expansion coefficient of air; and the convective heat-dissipation gas is at least one of helium, argon, hydrogen and neon.

5. The LED lamp of claim 1, wherein the substrate is connected to the LED chip using a flip-chip process or a wire bonding process in an inverted arrangement; and the LED chip is connected to the plurality of electrical connection circuits through solders.

6. The LED lamp of claim 1, wherein the substrate of an elongated sheet structure is made from a metal or a flexible circuit board; a thickness of the substrate is less than 0.6 mm; and a width of the substrate is less than 10 mm.

7. The LED lamp of claim 1, wherein a cross section of the bulb shell has one of a circular shape, a fan shape, an elliptical shape, a triangular shape and a trapezoidal shape.

8. The LED lamp of claim 1, wherein the LED chip is selected from one of a blue LED chip, a red LED chip, a yellow LED chip, a green LED chip, an ultraviolet LED chip and an infrared LED chip; and the LED chip is excited by phosphor.

9. The LED lamp of claim 1, wherein the vacuum sealed cavity is filled with dry air.

10. A process for making an LED lamp with a windable filament, comprising:
(1) fixing a substrate to a light bar;
(2) connecting an LED chip to the substrate using a flip-chip process or a wire bonding process in an inverted arrangement, wherein eutectic soldering, reflow soldering or conductive silver-filled epoxy adhesive is used in the process;
(3) coating a fluorescent colloid on a top of the substrate and the LED chip;
(4) winding the light bar;
(5) assembling the light bar, a bulb shell and a support into the lamp; and filling a vacuum sealed cavity of the lamp with convective heat-dissipation gas or dry air; and
(6) assembling a driver and an electrical connector to manufacture an LED lamp product.

11. The process of claim 10, wherein in step (2), both ends of the substrate are provided with a process cavity, respectively; and the process cavity is clamped by an elastic fixture so that the substrate is straightened for processing.
